(19) United States
(12) Patent Application Publication
(10) Pub. No.: US 2010/0162270 A1
(43) Pub. Date: Jun. 24, 2010

(54) SYSTEM AND METHOD FOR KEYBOARD BASED LOGOUT

(75) Inventors: Vinod Bijlani, Pune (IN); Purnima Ram Borate, Pune (IN); Abhijit Anant Telang, Pune (IN)

Correspondence Address: KALI LAW GROUP, P.C., P.O. BOX 60187, SUNNYVALE, CA, 94088-0187, US

(73) Assignee: INTERNATIONAL BUSINESS MACHINES CORPORATION, Armonk, NY (US)

(21) Appl. No.: 12/343,893

(22) Filed: Dec. 24, 2008

(51) Int. Cl. G06F 9/46

(52) U.S. Cl. 719/318

(57) ABSTRACT

Disclosed is method for terminating a user application by identifying an active instance of a user applications, wherein the user application includes a parent instance and one or more child instances and terminating all instances of the user application on receiving a request/event generated by a user application or system.

### TRADEMARKS

IBM® is a registered trademark of International Business Machines Corporation, Armonk, N.Y., U.S.A. Other names used herein may be registered trademarks, trademarks or product names of International Business Machines Corporation or other companies. Microsoft® is a registered trademark of Microsoft Corporation.

### BACKGROUND OF THE INVENTION

Online security has become a critical concern for a number of users using the online websites, especially where transaction are involved. Typically, while using such secure website to perform transactions a user needs to logout of the system after using the website. Often users find it troublesome and sometimes frustrating to locate the sign-out or log-out option on websites. With increased frequency and sophistication in hacking personal details such as credit card information and other personal details, it is but imperative for users to end the session as soon as the transactions are completed in order to prevent misuse of their identity. Despite this situation, there are a relatively large number of websites that do not offer a clear and obvious way of logging out, which sometimes may be attribute to poor user interface design or the user being encouraged to signed in.

### SUMMARY OF THE INVENTION

Embodiments of the invention relate to a system and method of terminating an active user application on detection of an event, wherein the event is specifically initiated by means of a hardware interface of the computer system. For the active application, all associated applications, whether child or parent application, are closed thereby ensuring that no associated application of the active application is left on the desktop.

Additional features and advantages are realized through the embodiments of the present invention. Other embodiments and aspects of the invention are described in detail herein and are considered a part of the claimed invention. For a better understanding of embodiments the invention with advantages and features, reference is made to the description and to the drawings.

### TECHNICAL EFFECTS

As a result of the summarized invention, technically an event such as a press of a button on an electronic device can identify an active application and close all related parent and child applications, thereby not leaving the device vulnerable to malicious elements.

### BRIEF DESCRIPTION OF THE DRAWINGS

These and further aspects of exemplary embodiments the invention will become apparent from and will be elucidated hereinafter with respect with reference made to the accompanying drawings. The drawings illustrate only exemplary embodiments of the invention, and together with the description, serve to further explain the embodiments disclosed. In the drawings

FIG. 1 is a data processing system of an exemplary embodiment of the invention;

FIG. 2 illustrates an exemplary embodiment of hardware feature embedded in the computer system of FIG. 1, configured to generate a termination event;

FIG. 3 illustrates an exemplary embodiment of an online trading website;

FIG. 4 illustrates an exemplary embodiment of the event generation on using the hardware feature of FIG. 3;

FIG. 5 illustrates an exemplary embodiment of completion of event generated of FIG. 4; and

### DETAILED INSCRIPTION OF THE INVENTION

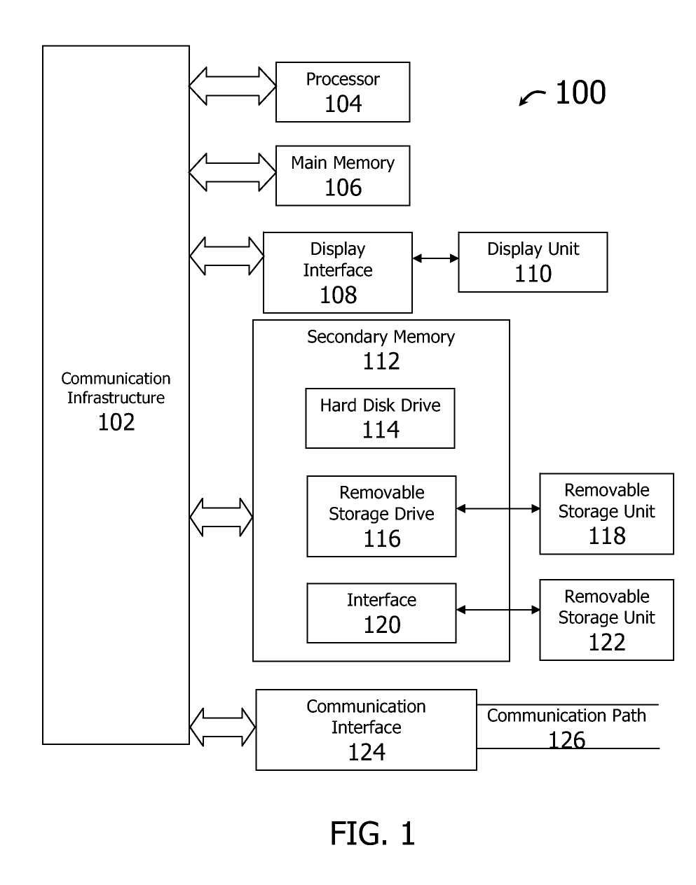

FIG. 1 is a block diagram of an exemplary data processing system 100, for example a computing system such as a desktop computer, laptop computer, PDA, mobile phone and the likes, that can be used for implementing exemplary embodiments of the present invention. Data processing system 100 includes one or more processors, such as processor 104. Processor 104 is connected to a communication infrastructure 102 (for example, a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

Exemplary data processing system 100 can include a display interface 108 that forwards graphics, text, and other data from the communication infrastructure 102 (or from a frame buffer not shown) for display on a display unit 110. Data processing system 100 also includes a main memory 106, which can be random access memory (RAM), and may also include a secondary memory 112. Secondary memory 112 may include, for example, a hard disk drive 114 and/or a removable storage drive 116, representing a floppy disk drive, a magnetic tape drive, an optical disk drive, etc. Removable storage drive 116 reads from and/or writes to a removable storage unit 118 in a manner well known to those having ordinary skill in the art. Removable storage unit 118, represents, for example, a floppy disk, magnetic tape, optical disk, etc. which is read by and written to by removable storage drive 116. As will be appreciated, removable storage unit 118 includes a computer usable storage medium having stored therein computer software and/or data.

In exemplary embodiments, secondary memory 112 may include other similar means for allowing computer programs or other instructions to be loaded into the computer system. Such means may include, for example, a removable storage unit 122 and an interface 120. Examples of such may include a program cartridge and cartridge interface (such as that found in video game devices), a removable memory chip (such as an EPROM, or PROM) and associated socket, and other removable storage units 122 and interfaces 120 which allow software and data to be transferred from the removable storage unit 122 to data processing system 100.

Data processing system 100 may also include a communications interface 124. Communications interface 124 allows software and data to be transferred between the computer system and external devices. Examples of communications interface 124 may include a modem, a network interface (such as an Ethernet card), a communications port, a PCMCIA slot and card, etc. Software and data transferred via communications interface 124 are in the form of signals which may be, for example, electronic, electromagnetic, optical, or other signals capable of being received by communications interface 124. These signals are provided to communications interface 124 via a communications path (that is, channel) 126. Channel 126 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 106 and secondary memory 112, removable storage drive 116, a hard disk installed in hard disk drive 114, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface, including a wired network or a wireless network, that allows a computer to read such computer readable information.

Computer programs (also called computer control logic) are stored in main memory 106 and/or secondary memory 112. Computer programs may also be received via communications interface 124. Such computer programs, when executed, can enable the computer system to perform the features of exemplary embodiments of the present invention as discussed herein. In particular, the computer programs, when executed, enable processor 104 to perform the features of data processing system 600. Accordingly, such computer programs represent controllers of the data processing system.

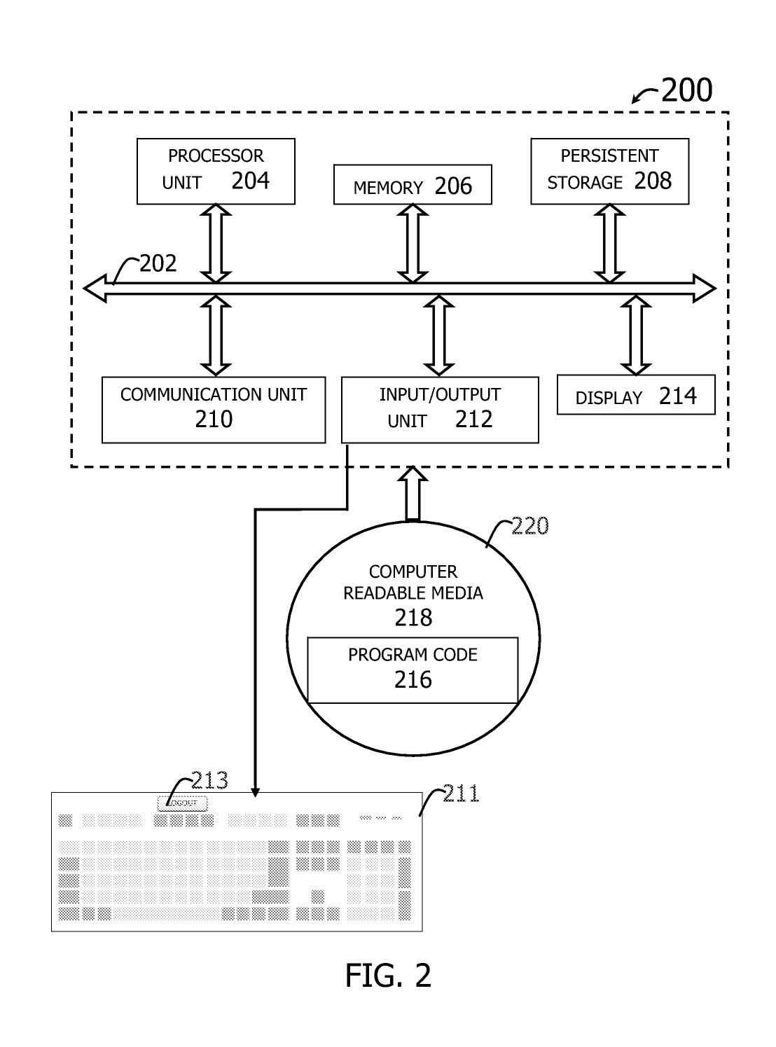

FIG. 2 illustrates an exemplary embodiment of a block diagram of a data processing system is shown in which illustrative embodiments may be implemented. Data processing system 200 is an example of a computer in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214 which have been disclosed with respect to FIG. 1.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user. In one embodiment, input unit 212 is a keyboard 211 provided with an additional hardware 213, which is when initiated by pressing, is configured to determine the active application, read the registry and determine all associated applications, whether parent or child and close those applications. In one embodiment the user may be provided an option to choose whether these applications should be closed. The hardware 213 can be provided as an additional button on the keyboard 211. Such buttons are for example already know in the art, where for example in a IBM Thinkpad™, has a button on the keypad labeled “ThinkVantage,” which on pressing generates an event initiating the operating system to perform a task, and displays a help screen from which the user may perform various tasks. It should be apparent to a person skilled in the art that the above is only an exemplary embodiment, and various other combinations may be constructed which are obvious to one skilled in the art.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form. In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

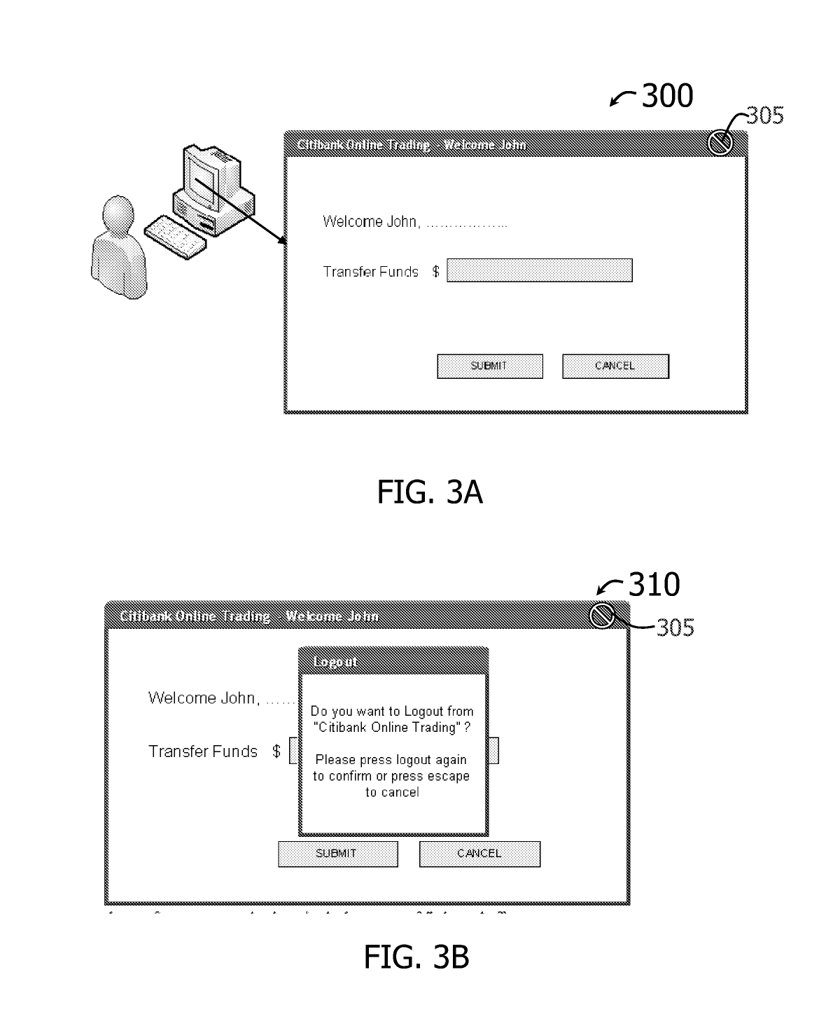

FIG. 3A illustrates an exemplary embodiment of a display of a website 300, that is displayed on the display 110 of data processing system 100. Website 300 is for example an online trading website displayed on a browser or a separate window opened from a website using a script, such as JavaScript. Browser is an application that executes on a data processing system 100/200 in conjunction with the operating system.

FIG. 3B illustrates an exemplary embodiment of a display, when button 213 of input unit 211 is activated. Activation of button 213 could include a press of the button located on the input unit such as a keyboard of data processing system. In one embodiment, user may be displayed a confirmation 310 as illustrated asking whether the user would like to close the active application, on selecting “submit” as indicated, the event generated by the press of button 213 to close all active application, determines from the registry all related application, which includes parent and child application, and closes all associated application including the active application.

FIG. 3C illustrates an exemplary embodiment of a confirmation 320 that the active application and all associated applications with the active application are closed. Once closed these would disappear from the task bar. In one embodiment, on press of button 213 the operating system detects that an event has been triggered to close the active application and all associated application, and would directly close all such application without confirming with the user. In a further embodiment, the event triggered would also ensure that sensitive/critical data stored in a cache are also erased when the active application is terminated.

As illustrated in FIGS. 3A and 3B, in one embodiment the trigger of the event may be provided on the application/window as illustrated by a button 305 in addition to the existing standard buttons of “minimize”, “maximize” and “close,” where the “close” button when clicked would close on the active application/window. Button 305, when clicked, determines from the registry the active window, determines the patent application and all associated child applications and closes all the applications/windows related to that application.

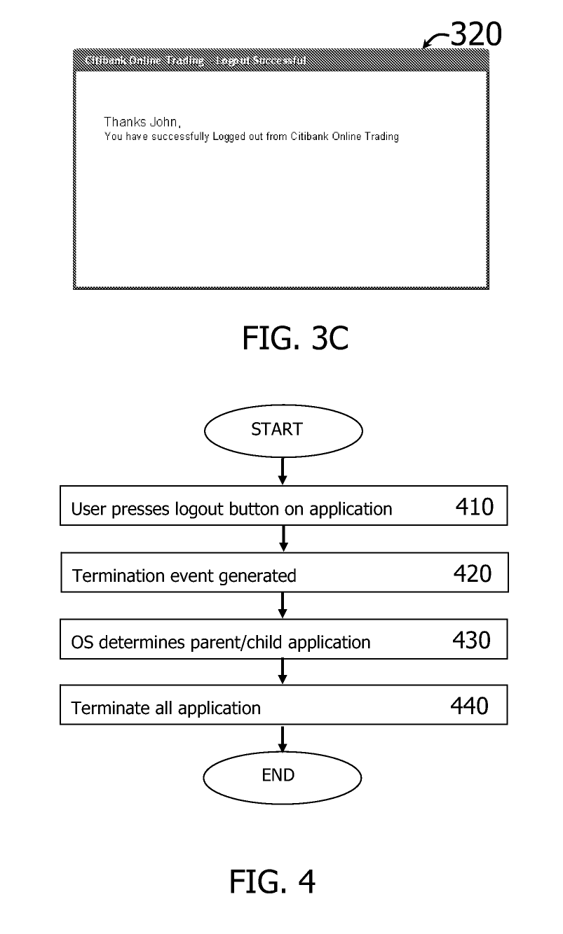

FIG. 4 illustrates an exemplary embodiment of a method for termination of applications using a button on the application/window of the application. Each application has a parent application and can have a number of child applications associated with the parent application. In Step 410 a user clicks on the button 305 as illustrated in FIG. 3A or FIG. 3B. In Step 420, on clicking the button 305 an event is triggered by the application to the operating system to close the active application and all related parent and child applications associated with the active window. In Step 430, the operating system recognizes the trigger from the active application and determines from the registry the parent application/window and all child applications/windows associated with the active window. In Step 440, all the applications associated with the active applications, including the active application are terminated and the cache of the system is freed.

For example, consider a user who opens a browser on the Window's operating system. Window's OS is a trademark of Microsoft Corporation. The user then click on a particular button in the contents of the window to open another window that runs a JavaScript, which allows the user to login to his account. The user may further open several other windows that may run JavaScript applications to perform a transaction to buy and sell shares etc. Once the user has completed, the user can click on the “close” button provided on the window, typically marked as “X,” and the active window is terminated. However if the user click on the button 305, then a termination event is triggered and the OS is intimated of the termination event. In this case, the OS is configured to check the registry for the parent and all child windows associated with the active window, create a list of these and send a termination signal to each of these, thereby closing all windows open that are associated with the active application.

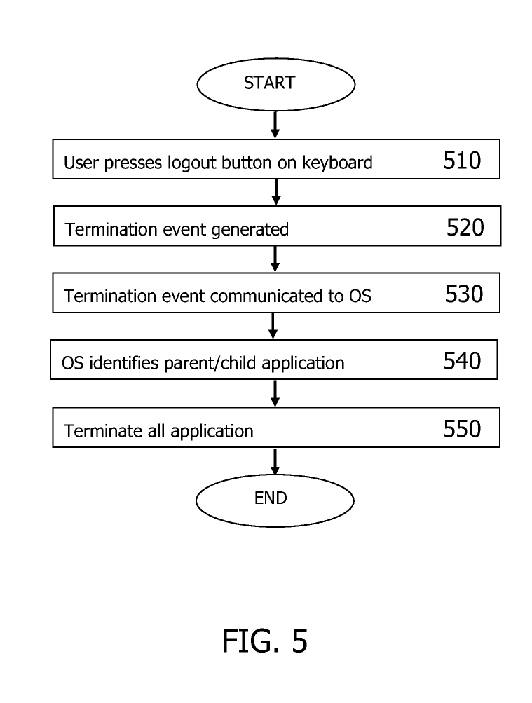

FIG. 5 illustrates an exemplary embodiment of a method for termination of applications using a button 213 provided on a keyboard of the system/device. Each application has a parent application and can have a number of child applications associated with the parent application. In Step 410 a user clicks on the button 213 provided on the keyboard 211 as illustrated in FIG. 2. In Step 420, on clicking the button 305 a termination event is triggered by the button. In Step 530 the termination event is sent to the OS and the OS on receiving the termination event where the termination specifies to the operating system to close the active application and all related parent and child applications associated with the active window. In Step 530, the operating system recognizes the trigger from the active application and determines from the registry the parent application/window and all child applications/windows associated with the active window. In Step 550, all the applications associated with the active applications, including the active application are terminated and the cache of the system is freed. The example of transaction discussed above can be terminated by pressing the button 213 provided on the keyboard.

Although exemplary embodiments of the invention have been described in detail, it should be understood that various changes, substitutions and alternations could be made thereto without departing from spirit and scope of the embodiments disclosed and defined by the appended claims. Variations described for exemplary embodiments of the invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the invention.

The described techniques may be implemented as a method, apparatus, system, device or an article of manufacture involving software, firmware, micro-code, hardware such as logic, memory and/or any combination thereof. The term “article of manufacture” as used herein refers to code or logic and memory implemented in a medium, where such medium may include hardware logic and memory [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.].

Code in the computer readable medium is accessed and executed by a processor. The medium in which the code or logic is encoded may also include transmission signals propagating through space or a transmission media, such as an optical fiber, copper wire, etc. The transmission signal in which the code or logic is encoded may further include a wireless signal, satellite transmission, radio waves, infrared signals, Bluetooth, the internet etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, a combination of hardware and software components may be included in which the code is embodied, processed, and executed. Of course, those skilled in the art will recognize that many modifications may be made without departing from the scope of embodiments, and in one embodiment any information bearing medium may be include. For example, this includes a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Elements that are in communication with each other need not be in continuous communication with each other, unless expressly specified otherwise. In addition, elements that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently. Further, some or all steps may be performed in run-time mode.

When a single element or article is described herein, it will be apparent that more than one element/article (whether or not they cooperate) may be used in place of a single element/article. Similarly, where more than one element or article is described herein (whether or not they cooperate), it will be apparent that a single element/article may be used in place of the more than, one element or article. The functionality and/or the features of an element may be alternatively embodied by one or more other elements which are not explicitly described as having such functionality/features. Thus, other embodiments need not include the element itself.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

The accompanying figures and this description depicted and described embodiments of the invention, and features and components thereof. Those skilled in the art will appreciate that any nomenclature and/or illustrations used in this description was merely for convenience, and thus the embodiments of the invention should not be limited to use solely in any specific application identified and/or implied by such nomenclature. Therefore, it is desired that the embodiments described herein be considered in all respects as illustrative, not restrictive, and that reference be made to the appended claims for determining the scope.

Although embodiments of the invention has been described with reference to the embodiments described above, it will be evident that other embodiments may be alternatively used to achieve the same object. The scope is not limited to the embodiments described above, but can also be applied to software programs and computer program products in general. It should be noted that the above-mentioned embodiments illustrate rather than limit the invention and that those skilled in the art will be able to design alternative embodiments without departing from the scope of the appended claims. In the claims, any reference signs should not limit the scope of the claim. Embodiments of the invention can be implemented by means of hardware comprising several distinct elements.

What is claimed is:

1. A method for terminating a user application, the method comprising
identifying an active instance of a user applications, wherein the user application includes a parent instance and one or more child instances; and
terminating all instances of the user application.

2. The method of claim 1, further comprises
receiving a request for terminating all instances of the user applications.

3. The method of claim 2, wherein the request is generated on click of at least one of
a button provided on the user application; or
a button provided on the keyboard.

4. The method of claim 2, wherein on receiving the request for termination the operating system is configured to perform
determining from the registry the parent instance and all child instances of the active instance of the user application.

5. The method of claim 3, wherein the button on the user application is a software means of triggering the event to terminate all instances of the user application associated with the active instance of the user application.

6. The method of claim 3, wherein the button on the keyboard is a hardware means of triggering the event to to terminate all instances of the user application associated with the active instance of the user application.

7. A data processing system comprising a processor and a memory configured for terminating a user application, wherein the operating system on the data processing system is configured to receive a request for terminating all instances of a user application, the operating system configured to
identify an active instance of a user applications, wherein the user application includes a parent instance and one or more child instances; and
terminate all instances of the user application.

8. The data processing system of claim 7, wherein the request for termination is generated on click of at least one of
a button provided on the user application; or
a button provided on the keyboard.

9. The data processing system of claim 7, wherein on receiving the request for termination the operating system is configured to perform
determining from the registry the parent instance and all child instances of the active instance of the user application.

10. The data processing system of claim 8, wherein the button on the user application is a software means of triggering the event to terminate all instances of the user application associated with the active instance of the user application.

11. The data processing system of claim 8, wherein the button on the keyboard is a hardware means of triggering the event to terminate all instances of the user application associated with the active instance of the user application.

12. The data processing system of claim 11, wherein a program to identify the active instance of the user application and generate a termination event of the active instance and all associated parent and child instances of the user application of the active application is stored on a embedded hardware.

13. The data processing system of claim 12, wherein on pressing the button on the keypad triggers the program to be executed on the data processing system.

14. The data processing system of claim 14, wherein the trigger initiates the operating system on the data processing system to close the active instance and all associated instances of the user application.

15. A storage medium tangibly embodying a program of machine-readable instructions to carry out a method of terminating a user application, the machine readable instructions executable by a digital processing apparatus capable of performing
identifying an active instance of a user applications, wherein the user application includes a parent instance and one or more child instances; and
terminating all instances of the user application.

16. The storage medium of claim 15, further comprises
receiving a request for terminating all instances of the user applications.

17. The storage medium of claim 16, wherein the request for termination is generated on click of at least one of
a button provided on the user application; or
a button provided on the keyboard.

18. The storage medium of claim 16, wherein on receiving the request for termination the operating system is configured to perform
determining from the registry the parent instance and all child instances of the active instance of the user application.

19. The storage medium of claim 17, wherein the button on the user application is a software means of triggering the event to terminate all instances of the user application associated with the active instance of the user application.

20. The storage medium of claim 17, wherein the button on the keyboard is a hardware means of triggering the event to terminate all instances of the user application associated with the active instance of the user application.
